(19) United States
(12) Patent Application Publication
(10) Pub. No.: US 2009/0047522 A1
(43) Pub. Date: Feb. 19, 2009

(54) Optical Reflective Film

(76) Inventors: Liang-Bin Yu, Sinjhuang City (TW); Yi-Han Chao, Taoyuan County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/838,956

(22) Filed: Aug. 15, 2007

(51) Int. Cl. B32B 23/08

(52) U.S. Cl. 428/409

(57) ABSTRACT

An optical reflective film that includes pluralities of repeating units is provided. The repeating unit includes a first multiplayer-film unit and a second multiplayer-film unit. The first multiplayer-film unit and the second multiplayer-film unit are by stacking a first polymeric material A and a second polymeric material B. The first polymeric material A and the second polymeric material B differ from each other in refractive index by at least about 0.03. The stacking order in the first multiplayer-film unit is 1A:xB:1A, and the stacking order in the second multiplayer-film unit is 1B:yA:1B, where x and y represent the optical thickness multiple of the middle polymeric material relative to the neighboring polymeric material. X and y are not equal and have a proportional relationship to each other. For the visible light, the ratio of the first multiplayer-film unit and the second multiplayer-film unit in the effective refractive index is about 1.00.

### BACKGROUND OF THE INVENTION

1. Field of the Invention

The present invention relates to an optical reflective film and particularly to an optical reflective film that can reflect light in an infrared region and allow visible light to pass through.

2. Description of the Prior Art

The general optical reflective film allows light of a selected wavelength region to pass through and reflect other light in other wavelength regions. U.S. Pat. No. 3,711,176 discloses an optical reflective film formed by stacking two polymeric layers. When polymers are selected to have a sufficient mismatch in refractive indices, these multiplayer cause films cause constructive interference of light. Thereby light of a selected wavelength can pass through the optical reflective film while light of other wavelengths is reflected.

The reflection and transmission spectrum for the polymeric layers are mainly depends on optical thickness of the polymeric layers. The optical thickness is the multiplication product of the thickness and the refractive index of the polymeric layers. Mathematically, the wavelength of the light of a first order wavelength reflected by the optical reflective film can be indicated through the following equation (1):

$${λ}_{I} = 2 {\sum }_{i = 1}^{k} ( {n}_{i} {d}_{i} ) \qquad ( 1 )$$

where λ₁ is the first order wavelength, nᵢ is the refractive index of the polymeric layers, d is the thickness of the polymeric layers and k is the number of the polymeric layers. Aside from reflecting the light of the first order wavelength, the optical reflective film can also reflect light of a higher order wavelength.

Mathematically, the wavelength of the light of the higher order wavelength reflected by the optical reflective film can be indicated through the following equation (2)

$${λ}_{m} = ( 2 / m ) {\sum }_{i = 1}^{k} ( {n}_{i} {d}_{i} ) \qquad ( 2 )$$

where λₘ is the higher order wavelength, and m is an integer greater than 1. Equation (2) indicates that λₘ is smaller than λ₁. Hence in the event that λₘ is within the wavelength region of a near infrared light, namely, with the wavelength between 780 nm and 2500 nm, some of λₘ are visible lights, namely with the wavelength between 380 nm and 780 nm. For instance, if λ₁ is 1800 nm, λ₂ and λ₃ are respectively 900 nm and 600 nm. As a result, a phenomenon of iridescence is formed on the optical reflective film.

However, in some applications it is not desirable to reflect the visible light of the higher order wavelength. For instance, for the optical reflective film adhered to the glass of buildings, reflecting the external infrared light is required to reduce the load of the air conditioning system. But the optical reflective film also has to allow the visible light to pass through to generate sufficient illumination in the buildings. The optical reflective film disclosed in U.S. Pat. No. 3,711,176 cannot meet such a requirement.

To remedy the aforesaid problem, U.S. Pat. No. 5,360,659 discloses another type of optical reflective film formed by stacking two polymeric layers of different refractive indices. The stacking order adopts 1L:7H:1L:1H:7L:1H; where H represents the polymeric layer of a higher refractive index, and L represents the polymeric layer of a lower refractive index. The number in front of H and L (namely 7 or 1) indicates the optical thickness ratio of the polymeric layers. Simulation shows that the optical reflective film of U.S. Pat. No. 5,360,659 can effectively reflect near infrared light and allow visible light to pass through.

However, in some circumstances restricting the stacking order of the polymeric layers adopted in U.S. Pat. No. 5,360,659 is not commendable. How to expand the selection range of the stacking order of the polymeric layers and also achieve the effect of reflecting the near infrared light and allowing the visible light to pass through is an issue pending to be resolved in the industry.

### SUMMARY OF THE INVENTION

It is an object of the present invention to provide an optical reflective film formed by stacking polymeric layers in a wider selection range to reflect near infrared light and allow visible light to pass through.

To achieve the foregoing object the optical reflective film of the invention is formed by stacking a plurality of repeating units. Each of the repeating units has a first multiplayer film unit and a second multiplayer film unit. The first multiplayer film unit and the second multiplayer film unit are both formed by stacking a first polymeric layer A and a second polymeric layer B. The first polymeric layer A and the second polymeric layer B have refractive indices that differ at least 0.03. The first multiplayer film unit is formed through a stacking order of 1A:xB:1A, where x represents the optical thickness multiple of the second polymeric layer B relative to the adjacent first polymeric layer A. The second multiplayer film unit is formed through another stacking order of 1B:yA:1B, where y represents the optical thickness multiple of the first polymeric layer A relative to the second polymeric layer B. x and y are different but in a proportional relationship. For light in the visible wavelength range the ratio of the equivalent refractive indices of the first multiplayer film unit and the second multiplayer film unit approximates 1.00.

In one aspect the refractive index difference of the first polymeric layer A and the second polymeric layer B is at least 0.05.

In another aspect, the range of the refractive index of the polymeric layer A and the second polymeric layer B is between 1.4 and 2.0.

In yet another aspect, the range of the refractive index of the polymeric layer A and the second polymeric layer B is between 1.5 and 1.85.

In yet another aspect the refractive index difference of the first polymeric layer A and the second polymeric layer B is between 0.05 and 0.2.

In yet another aspect, the first polymeric layer A and the second polymeric layer B are made from material selected from the group including polycarbonate, polystyrene, polyethylene terephthalate, and polymethyl methacrylate.

In yet another aspect x and y are not equal. In embodiments of the invention, the ratio of x and y may be 7.2:6.8, or 6.8:7.2.

In yet another aspect the difference between x and y may be greater than 2. In embodiments of the invention, the ratio of x and y may be 8.4:6, or 6:8.4.

In yet another aspect the difference between x and y may be greater than 4. In embodiments of the invention, the ratio of x and y may be 10:5.4, or 5.4:10.

In yet another aspect the difference between x and y may be greater than 5. In embodiments of the invention, the ratio of x and y may be 10.8:5.2, or 5.2:10.8.

In yet another aspect of the invention the thickness of each repeating unit varies according to the thickness direction of the optical reflective film. In embodiments of the invention the thickness of each repeating unit increases or decreases linearly or exponentially according to the thickness direction of the optical reflective film. However this is not the limitation.

Through the invention the selection range of the stacking orders of the polymeric layers can be expanded to enable the optical reflective film to reflect near infrared light and also allow the visible light to pass through.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of the optical reflective film of the invention.

FIGS. 2A and 2B are tables showing the relationship of x and y, and E₁/E₂ in the condition of n_{A}=1.5 and n_{B}=1.6.

FIGS. 3A and 3B are tables showing the relationship of x and y, and E₁/E₂ in the condition of n_{A}=1.5 and n_{B}=1.7.

FIGS. 4A and 4B are tables showing the relationship of x and y, and E₁/E₂ in the condition of n_{A}=1.5 and n_{B}=1.9.

FIG. 5 is a chart showing the comparison of light filtering function of the optical reflective film of the invention and a conventional optical reflective film.

### DESCRIPTION OF THE PREFERRED EMBODIMENTS

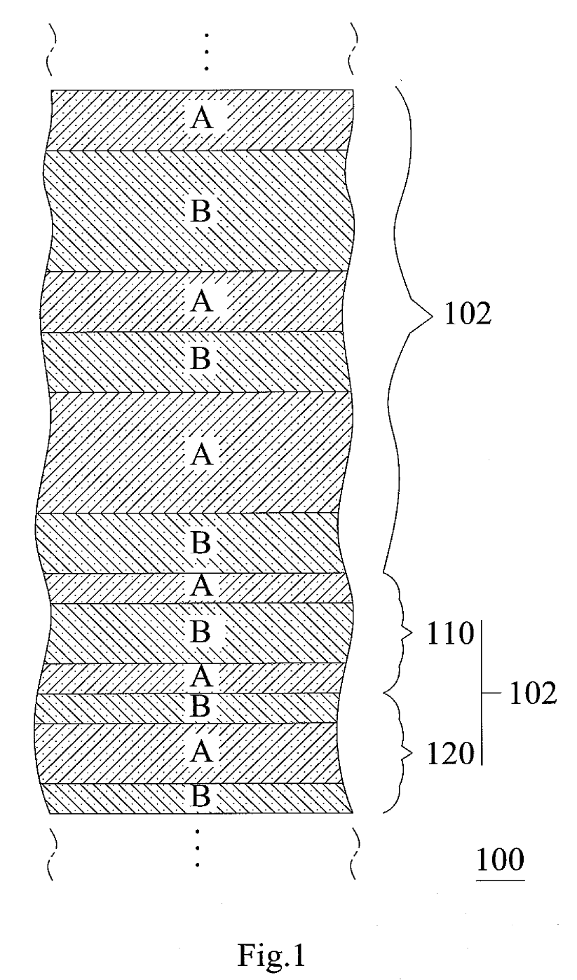

Referring to FIG. 1, the optical reflective film 100 according to the invention is formed by stacking a plurality of repeating units 102. Each of the stacking units 102 is formed at a thickness which varies according to the thickness direction of the optical reflective film 100, such as increases or decrease linearly or exponentially according thickness increase of the optical reflective film. In FIG. 1, the thickness of the repeating units 102 increases according to thickness increase of the optical reflective film 100. The thickness of the repeating unit 102 at the upper side is two times of the thickness of the lower side.

Each repeating unit 102 consists of a first multiplayer film unit 110 and a second multiplayer film unit 120. The first multiplayer film unit 110 and the second multiplayer film unit 120 are formed by stacking a first polymeric layer A and a second polymeric layer B together. The first multiplayer film unit 110 is formed by sandwiching one second polymeric layer B between two first polymeric layers A. The second multiplayer film unit 120 is formed by sandwiching one first polymeric layer A between two second polymeric layers B. On the first multiplayer film unit 110 the stacking order adopts 1A:xB:1A, where x represents the multiple of the optical thickness of the second polymeric layer B relative to the adjacent first polymeric layer A. For instance, if the stacking order of the first multiplayer film unit 110 adopts 1A:7B:1A, the optical thickness of the second polymeric layer B is 7 times of the adjacent first polymeric layer A. The stacking order for the second multiplayer film unit 120 adopts 1B:yA:1B, where y represents the multiple of the first polymeric layer A relative to the adjacent second polymeric layer B. x and y are in a proportional relationship. For instance, if x=7 and y=9, the optical thickness ratio of the second polymeric layer B on the first multiplayer film unit 110 and the first polymeric layer A on the second multiplayer film unit 120 is 7:9.

Moreover, for a given wavelength, the closer the equivalent refractive index E₁ of the first multiplayer film unit 110 to the equivalent refractive index E₂ of the second multiplayer film unit 120, the light of that given wavelength is easier to pass through the repeating unit 102. In practice, for light within the range of visible wavelength, when the ratio of E₁ and E₂ approximates 1.00, the light can pass through the repeating unit 102 easier. The equivalent refractive index E₁ of the first multiplayer film unit 110 can be derived through the following equation (3):

$${m}_{1} = \frac{1}{{n}_{A}} [ \begin{matrix}sin 2 {δ}_{A} cos {δ}_{B} + \frac{1}{2} ( \frac{{n}_{B}}{{n}_{A}} + \frac{{n}_{A}}{{n}_{B}} ) cos 2 {δ}_{A} sin {δ}_{B} + \\ \frac{1}{2} ( \frac{{n}_{A}}{{n}_{B}} - \frac{{n}_{B}}{{n}_{A}} ) sin {δ}_{B}\end{matrix} ] \\ {o}_{1} = {n}_{A} [ \begin{matrix}sin 2 {δ}_{A} cos {δ}_{B} + \frac{1}{2} ( \frac{{n}_{B}}{{n}_{A}} + \frac{{n}_{A}}{{n}_{B}} ) cos 2 {δ}_{A} sin {δ}_{B} - \\ \frac{1}{2} ( \frac{{n}_{A}}{{n}_{B}} - \frac{{n}_{B}}{{n}_{A}} ) sin {δ}_{B}\end{matrix} ] \\ {E}_{1} = \sqrt{\frac{{o}_{1}}{{m}_{1}}} \qquad ( 3 )$$

where

$${δ}_{A} = \frac{2 π}{λ} {n}_{A} {d}_{A}$$

$$and$$

$${δ}_{B} = \frac{2 π}{λ} {n}_{B} {d}_{B} ,$$

and d_{A} and d_{B} represent respectively the thickness of the first polymeric layer A and the second polymeric layer B. In terms of the light with a wavelength of λ, n_{A} and n_{B} represent respectively the refractive indices of the first polymeric layer A and the second polymeric layer B.

The equivalent refractive index E₂ of the second multiplayer film unit 120 can be derived through the following equation (4):

$${m}_{2} = \frac{1}{{n}_{B}} [ \begin{matrix}sin 2 {δ}_{B} cos {δ}_{A} + \frac{1}{2} ( \frac{{n}_{A}}{{n}_{B}} + \frac{{n}_{B}}{{n}_{A}} ) cos 2 {δ}_{B} sin {δ}_{A} + \\ \frac{1}{2} ( \frac{{n}_{B}}{{n}_{A}} - \frac{{n}_{A}}{{n}_{B}} ) sin {δ}_{B}\end{matrix} ] \\ {o}_{2} = {n}_{B} [ \begin{matrix}sin 2 {δ}_{B} cos {δ}_{A} + \frac{1}{2} ( \frac{{n}_{A}}{{n}_{B}} + \frac{{n}_{B}}{{n}_{A}} ) cos 2 {δ}_{B} sin {δ}_{A} - \\ \frac{1}{2} ( \frac{{n}_{B}}{{n}_{A}} - \frac{{n}_{A}}{{n}_{B}} ) sin {δ}_{A}\end{matrix} ] \\ {E}_{2} = \sqrt{\frac{{o}_{2}}{{m}_{2}}} \qquad ( 4 )$$

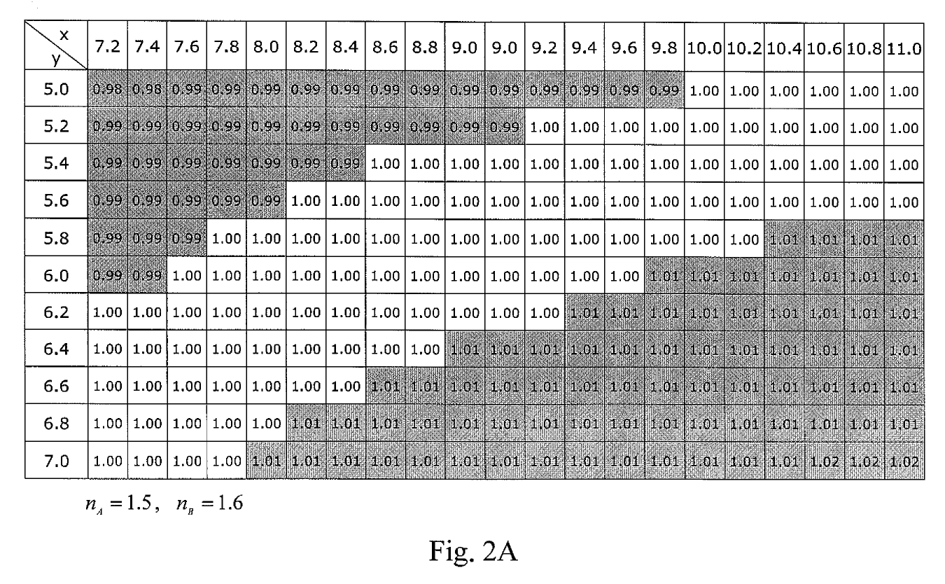

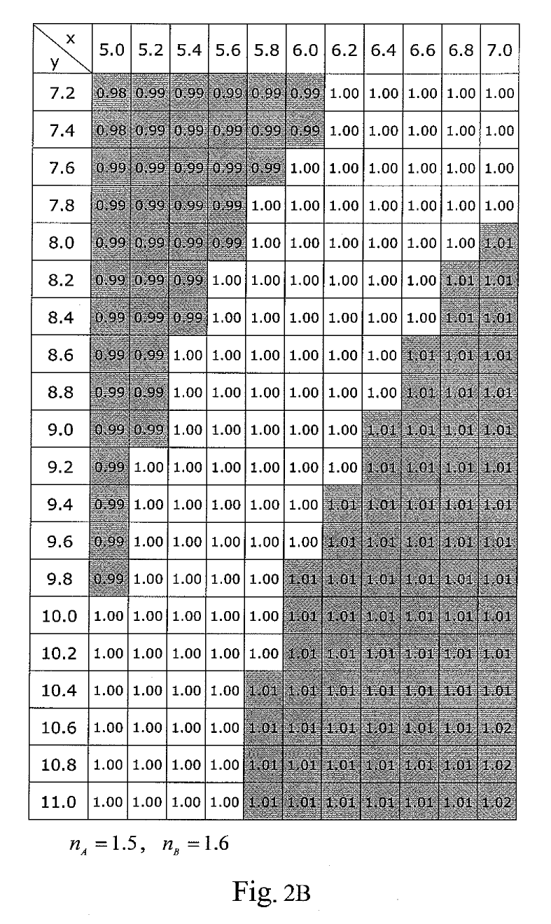

In a condition in which the wavelength λ of incident light is known, by altering the optical thickness ratio of the first polymeric layer A and the second polymeric layer B and through the equation (3), change of E₁/E₂ can be obtained when x and y vary. Refer to FIGS. 2A and 2B for the relationship of x and y and E₁/E₂ when n_{A}=1.5 and n_{B}=1.6. In FIGS. 2A and 2B, the top row shows x values, the leftmost column shows y values. The rest is the values of E₁/E₂ with the precision up to two digits after the decimal point.

Through FIGS. 2A and 2B, in a condition in which x and y are not equal, the value of E₁/E₂ can be maintained at 1.00 by selecting desired x and y. Hence through the approach of the invention previously discussed, the selection range of x and y can be expanded without limiting to the stacking order indicated in U.S. Pat. No. 5,360,659.

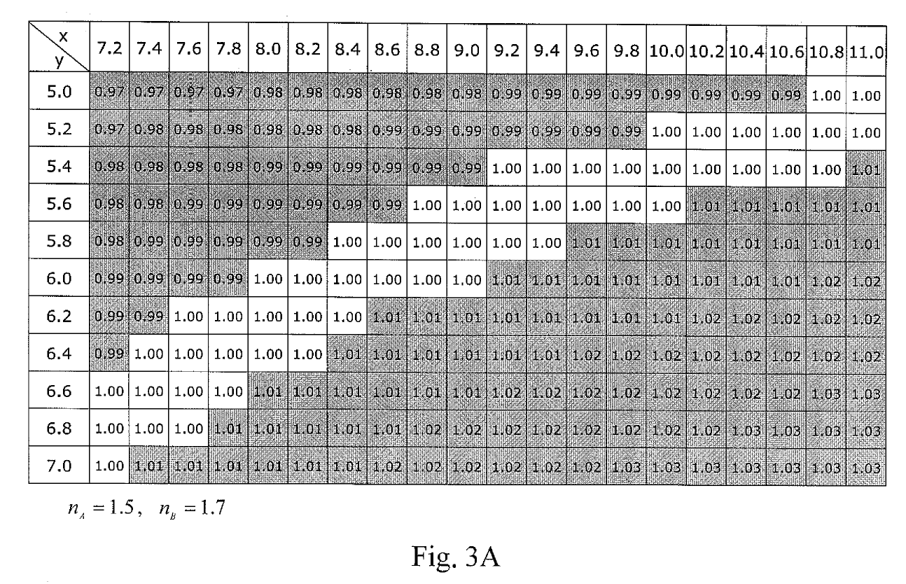

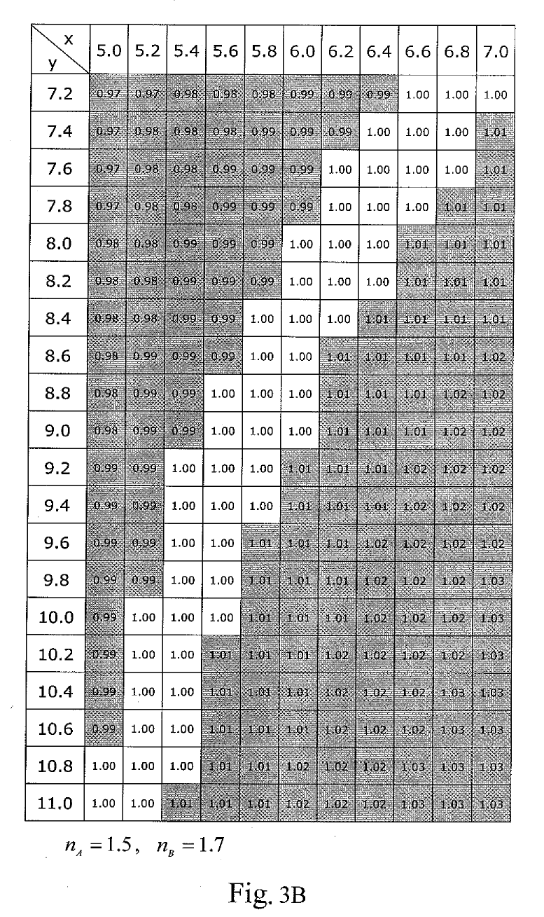

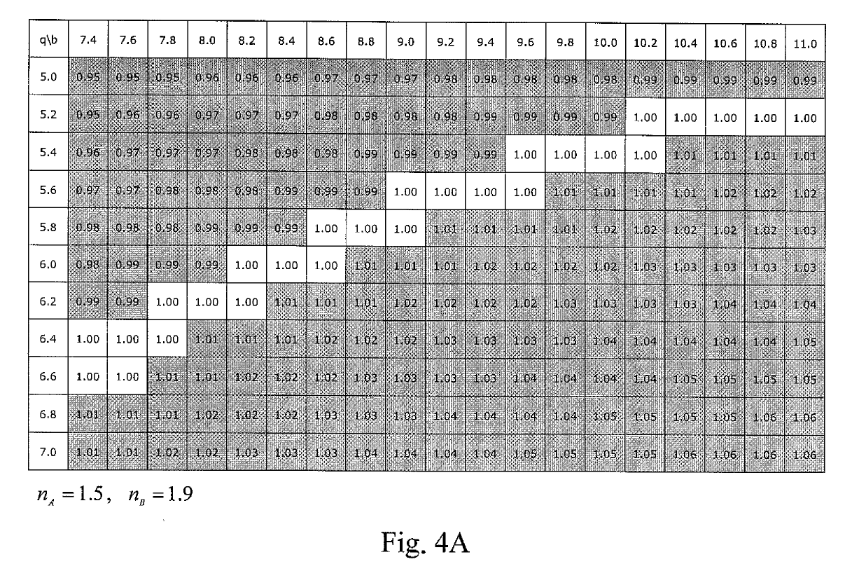

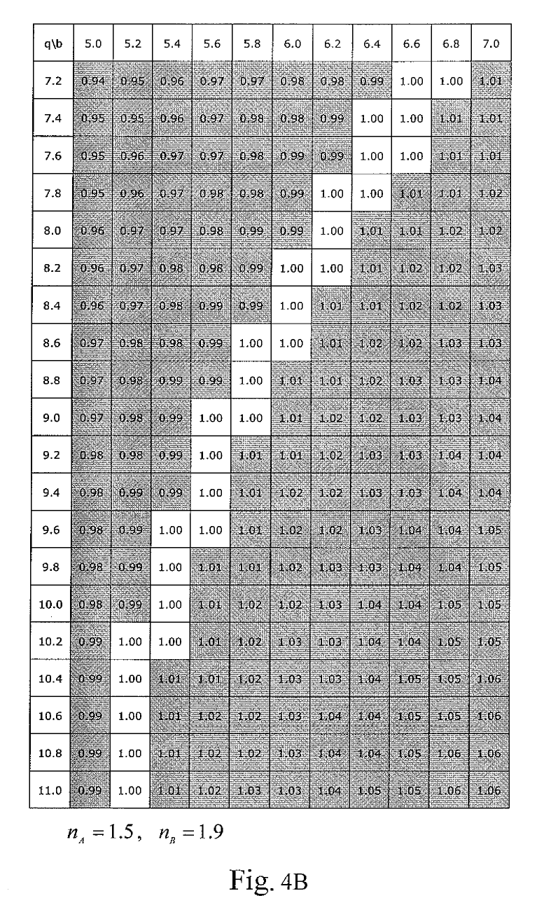

Refer to FIGS. 3A and 3B for the relationship of x and y and E₁/E₂ when n_{A}=1.5 and n_{B}=1.7, and FIGS. 4A and 4B for the relationship of x and y and E₁/E₂ when n_{A}=1.5 and n_{B}=1.9. Compare FIGS. 2A and 2b with FIGS. 3A and 3B, and 4A and 4B, when the difference of n_{A} and n_{B} is smaller, the selection range of x and y is greater. The refractive index difference of the first polymeric layer A and the second polymeric layer B is preferably between 0.05 and 0.2. And the refractive indices of the first polymeric layer A and the second polymeric layer B are in the range of 1.4 and 2.0, preferably between 1.5 and 1.85. Moreover, the first polymeric layer A and the second polymeric layer B are made from material selected from the group including polycarbonate, polystyrene, polyethylene terephthalate, polymethyl methacrylatem and a compound thereof. Other polymers such as Polyethylene Terephthalate Glycol, Polycyclohexylenedimethylene Terephthalate Glycol and Polyethylene Naphthalate may also be used.

It also found that when the difference of x and y is between 2 and 4, the preferable ratio of x and y approximates 8.4:6 or 6:8.4. When the difference of x and y is between 4 and 5, the preferable ratio of x and y approximates 10:5.4, or 5.4:10. When the difference of x and y is more than 5, the preferable ratio of x and y approximates 10.8:5.2, or 5.2:10.8. Namely, in all of the above conditions, the ratio of E₁ and E₂ is closer, and the visible light can more easily pass through the repeating unit 102.

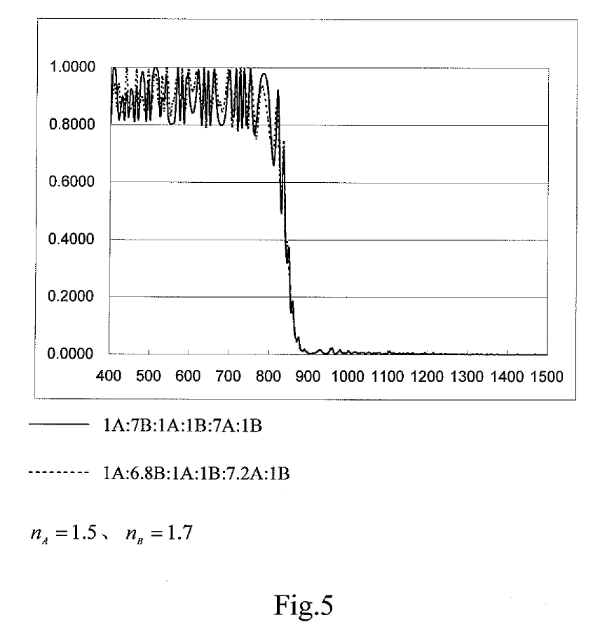

Refer to FIG. 5 for a chart showing the comparison of light filtering function of the optical reflective film of the invention and a conventional optical reflective film. The solid line indicates the result of the optical reflective film formed by the stacking order of 1A:7B:1A:1B:7A;1B (namely the one taught by U.S. Pat. No. 5,360,659). The broken line indicates the result of the optical reflective film formed according to a stacking order of 1A:6.8B:1A:1B:7.2A;11B. Both optical reflective films have 1800 polymeric layers. The refractive index n_{A} of the first polymeric layer A is 1.5, and the refractive index n_{B} of the second polymeric layer B is 1.7. FIG. 5 shows a simulation result in which the optical reflective film of the invention and the conventional optical reflective film all have similar light filtering effectiveness.

In short, the optical reflective film of the invention can increase the selection range of the stacking order of the polymeric layers, and reflect the near infrared light and allow the visible light to pass through.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An optical reflective film comprising a plurality of stacked repeating units, each of the repeating units having a first multiplayer film unit and a second multiplayer film unit, the first multiplayer film unit and the second multiplayer film unit both being formed by stacking a first polymeric layer and a second polymeric layer that have refractive indices differing at least by 0.03; wherein the first polymeric layer is stacked in an order of 1A:xB:1A, where x represents a multiple of an optical thickness of the second polymeric layer relative to the adjacent first polymeric layer; wherein the second polymeric layer is stacked in an order of 1B:yA:1B, where y represents another multiple of the optical thickness of the first polymeric layer relative to the adjacent second polymeric layer; wherein x and y are not equal and form a proportional relationship, the first multiplayer film unit and the second multiplayer film unit having respectively an equivalent refractive index at a ratio approximating 1.00 for visible light.

2. The optical reflective film of claim 1, wherein the refractive indices of the first polymeric layer and the second polymeric layer differ at least by 0.05.

3. The optical reflective film of claim 1, wherein the refractive indices of the first polymeric layer and the second polymeric layer are in a range between 1.4 and 2.0.

4. The optical reflective film of claim 1, wherein the refractive indices of the first polymeric layer and the second polymeric layer are in a range between 1.5 and 1.85.

5. The optical reflective film of claim 1, wherein the refractive indices of the first polymeric layer and the second polymeric layer differ between 0.05 and 0.2.

6. The optical reflective film of claim 1, wherein the first polymeric layer and the second polymeric layer are made from material selected from the group including polycarbonate, polystyrene, polyethylene terephthalate, and polymethyl methacrylate.

7. The optical reflective film of claim 1, wherein x and y differ greater than 2.

8. The optical reflective film of claim 7, wherein the proportional relationship of x and y approximates 8.4:6 or 6:8.4.

9. The optical reflective film of claim 1, wherein x and y differ greater than 4.

10. The optical reflective film of claim 9, wherein the proportional relationship of x and y approximates 10:5.4 or 5.4:10.

11. The optical reflective film of claim 1, wherein x and y differ greater than 5.

12. The optical reflective film of claim 11, wherein the proportional relationship of x and y approximates 10:8:5.2 or 5.2:10.8.

13. The optical reflective film of claim 1, wherein the thickness of each repeating unit varies according to thickness direction of the optical reflective film.

14. The optical reflective film of claim 1, wherein the thickness of each repeating units increases or decreases according to thickness direction of the optical reflective film.

15. The optical reflective film of claim 13, wherein the thickness of each repeating units increases or decreases linearly according to thickness direction of the optical reflective film.

16. The optical reflective film of claim 13, wherein the thickness of each repeating units increases or decreases exponentially according to thickness direction of the optical reflective film.

17. The optical reflective film of claim 1, wherein the proportional relationship of x and y approximates 7.2:6.8 or 6.8:7.2.

18. The optical reflective film of claim 1, wherein the first polymeric layer and the second polymeric layer are made from material selected from Polyethylene Terephthalate Glycol, Polycyclohexylenedimethylene Terephthalate Glycol and Polyethylene Naphthalate.
